(19) United States
(12) Patent Application Publication
(10) Pub. No.: US 2023/0245835 A1
(43) Pub. Date: Aug. 3, 2023

(54) SEPARATOR FOR ALUMINUM ELECTROLYTIC CAPACITOR, AND ALUMINUM ELECTROLYTIC CAPACITOR

(71) Applicant: NIPPON KODOSHI CORPORATION, Kochi-shi, Kochi (JP)

(72) Inventors: Masaki ISHIGAYASUMI, Kochi-shi (JP); Takuya MURAOKA, Kochi-shi (JP); Takafumi OCHI, Kochi-shi (JP); Hironori KUMAOKA, Kochi-shi (JP)

(73) Assignee: NIPPON KODOSHI CORPORATION, Kochi-shi, Kochi (JP)

(21) Appl. No.: 18/014,329

(22) PCT Filed: Jul. 30, 2021
(86) PCT No.: PCT/JP2021/028336

§ 371 Date: Jan. 3, 2023

(30) Foreign Application Priority Data
Aug. 20, 2020 (JP) 2020-139532

(51) Int. Cl. H01G 9/02; H01G 9/045; H01G 9/028; H01G 9/15

(52) U.S. Cl. CPC H01G 9/02; H01G 9/045; H01G 9/028; H01G 9/151

(57) ABSTRACT

A resistance to short-circuiting of a separator to be used in an aluminum electrolytic capacitor having a conductive polymer is improved. A separator for an aluminum electrolytic capacitor, that is interposed between a pair of electrodes and is used in an aluminum electrolytic capacitor having a conductive polymer as a cathode material, is configured to include synthetic fibers and a binder and to have a bursting strength of 40-180 kPa and a burst index of 3.5-7.5 kPa/(g/m²).

### TECHNOLOGICAL FIELD

The present invention relates to a separator for an aluminum electrolytic capacitor and an aluminum electrolytic capacitor using the separator.

### BACKGROUND ART

In recent years, electronic equipment and automobile electrical equipment have been enhanced in functionality. Therefore, it is required to increase the speed of a computer used in these equipment. A key to speeding up the computer is speeding up the processing speed of a CPU. As the processing speed of the CPU increases, the operation frequency further increases. Therefore, a capacitor used in a power supply circuit is required to have improved characteristics at high frequencies.

In an aluminum electrolytic capacitor using an electrolytic solution as a cathode material (hereinafter, referred to as a “non-solid electrolytic capacitor”), it is difficult to improve high-frequency characteristics. Therefore, aluminum electrolytic capacitors using a conductive polymer as a cathode material (hereinafter, referred to as “solid electrolytic capacitors”) have been put on the market. The solid electrolytic capacitor is characterized by having lower equivalent series resistance (ESR) and more excellent high-frequency characteristics than the non-solid electrolytic capacitor.

In recent years, aluminum electrolytic capacitors using both a conductive polymer and an electrolytic solution as cathode materials (hereinafter, referred to as “hybrid electrolytic capacitors”) have also been put on the market. The hybrid electrolytic capacitor has characteristics of both the non-solid electrolytic capacitor and the solid electrolytic capacitor. That is, it is characterized in that the ESR is as low as that of the solid electrolytic capacitor while the capacitance characteristic is as high as that of the non-solid electrolytic capacitor.

A conduction mechanism of a conductive polymer is electron conduction, and exhibits higher conductivity than that of the electrolytic solution whose conduction mechanism is ion conduction. Therefore, the solid electrolytic capacitor and the hybrid electrolytic capacitor using the conductive polymer as a cathode material (hereinafter, the solid electrolytic capacitor and the hybrid electrolytic capacitor are collectively referred to as a “conductive polymer capacitor”) can have lower ESR than the non-solid electrolytic capacitor.

Unlike the non-solid electrolytic capacitor, the solid electrolytic capacitor does not use an electrolytic solution as the cathode material. The electrolytic solution does not evaporate from a sealed portion, so that the solid electrolytic capacitor can have a long life. The solid electrolytic capacitors have been widely used particularly in applications such as wireless communication base stations and servers for data centers, which are required to reduce the frequency of maintenance.

The hybrid electrolytic capacitors are used in various applications from the viewpoints of reduction in the number of components, space-saving, and weight reduction. Among them, in automobile applications such as electric power steering and advanced driver support systems, safety and reliability are emphasized for the components to be used. Therefore, the mounted component is required to safely end its life in case of failure. The hybrid electrolytic capacitors have been widely used in automobile applications because the failure mode is open.

There are two methods for forming a conductive polymer layer of the conductive polymer capacitor. One is a method (hereinafter, referred to as a “polymerization liquid type”) in which an element obtained by winding electrode foils and a separator together is impregnated with a polymerization liquid (monomer and oxidant solution) of a conductive polymer, and then the polymerization liquid is polymerized in the element to form the conductive polymer layer. The other is a method (hereinafter, referred to as a “dispersion liquid type”) in which the wound element is impregnated with a dispersion liquid of a conductive polymer (dispersion liquid containing a conductive polymer as a dispersoid), and then is dried to remove a dispersion medium, thereby forming the conductive polymer layer.

The dispersion liquid type conductive polymer capacitors are said to have better withstand voltage characteristics than the polymerization liquid type conductive polymer capacitors, and are used in applications requiring a rated voltage of about 50-60 V. However, for both the polymerization liquid type and the dispersion liquid type, some circuits cannot be applied due to insufficient withstand voltages, so that there is a demand for a conductive polymer capacitor having a higher rated voltage than before.

For these reasons, the conductive polymer capacitor is required to improve withstand voltage characteristics, that is, to suppress occurrence of a short-circuit failure while maintaining low ESR that is a characteristic when compared with the non-solid electrolytic capacitor. The separator to be used is required to improve resistance to short-circuiting while having good impregnation property and retention property of the polymerization liquid or dispersion liquid of a conductive polymer.

An example of the separator to be used in the conductive polymer capacitor includes a cellulose separator. In general, the cellulose separator is used by being subjected to a carbonization treatment after the element is produced. This has mainly two purposes. One is to suppress a reaction between a hydroxyl group of cellulose and an oxidant by subjecting the cellulose separator to a carbonization treatment. The other object is to improve the impregnation property and retention property of the polymerization liquid or dispersion liquid of the conductive polymer since voids between fibers constituting the separator are increased by the carbonization treatment.

While the carbonization treatment of the cellulose separator has the above effects, thermal decomposition of the cellulose occurs due to the heat applied in the carbonization treatment, and the mechanical strength of the separator is decreased by the thermal decomposition. Furthermore, cellulose molecules are gradually decomposed under acidic conditions, so that even when the element is impregnated with the polymerization liquid or dispersion liquid of the conductive polymer that is acidic, the mechanical strength of the separator is remarkably decreased.

In order to avoid such a problem of the cellulose separator, a separator in which synthetic fibers are blended is used, and for example, the techniques of Patent Literatures 1 to 4 are disclosed.

### CITATION LIST

### Patent Literature

Patent Literature 1: JP 2004-235293 A
Patent Literature 2: JP 2018-73895 A
Patent Literature 3: JP 2019-176074 A
Patent Literature 4: JP 2004-146137 A

### SUMMARY OF INVENTION

### Technical Problem

Patent Literature 1 discloses a separator that contains, as the synthetic fibers, non-fibrillated organic fibers and a fibrillated polymer having a melting point or a thermal decomposition temperature of 250° C. or higher, and that has a water absorption rate of 5 mm/min or more. It is said that, by using this separator, the formation of the conductive polymer in the solid electrolytic capacitor becomes uniform and the ESR of the solid electrolytic capacitor can be reduced.

The separator of Patent Literature 1 uses a fibrillated polymer that is very thin and has a large aspect ratio. Therefore, it is possible to densify the separator by greatly increasing the number of the fibers in the separator and increasing frequencies of entanglement of the fibrillated polymers with each other and with other fibers.

Even in a dense separator as in Patent Literature 1, however, the mechanical strength, such as a tensile strength or a tear strength, is weak and occurrence of a short-circuit failure cannot be suppressed. When the content of the fibrillated polymer is increased in order to improve the resistance to short-circuiting of the separator of Patent Literature 1, the denseness of the separator is excessively increased, the impregnation property of the polymerization liquid or dispersion liquid of the conductive polymer is deteriorated, and the ESR cannot be reduced.

Patent Literature 2 discloses a wet nonwoven fabric including synthetic fibers having an average pore size in the range of 0.5-15 μm and a wet tensile strength, after being immersed in ion-exchanged water at 70° C. for 30 minutes, of 0.30 kN/m or more. It is said that, by controlling the average pore size to be within the range of 0.5-15 μm and the wet tensile strength, after being immersed in ion-exchanged water at 70° C. for 30 minutes, to be 0.3 kN/m or more, the denseness of the separator is secured and the shape of the separator in a re-chemical conversion step can be maintained. Therefore, occurrence of a short-circuit failure in the aluminum electrolytic capacitor can be suppressed.

Patent Literature 3 discloses a wet nonwoven fabric containing polyester-based fibers, a polyester binder, and a polyvinyl alcohol binder, in which the average pore size is in the range of 5.0-20.0 μm, the frequency of pore sizes in the range of 5.0-15.0 μm is 70% or more based on all of the pore sizes, and the frequency of pore sizes of 20.0 μm or more is 10% or less. It is said that, with this configuration, gaps between the fibers constituting the separator can be homogenized, so that the impregnation property of the polymerization liquid or dispersion liquid of the conductive polymer can be increased while the resistance to short-circuiting of the separator is increased. It is reported that, therefore, an aluminum electrolytic capacitor using this separator can simultaneously achieve an improvement in electrostatic capacitance and a reduction in short-circuit failure rate.

The separators described in Patent Literature 2 and Patent Literature 3 can suppress occurrence of a short-circuit failure by controlling the average pore sizes of the separators. Even in these separators, however, it is difficult to suppress occurrence of a short-circuit failure while suppressing deterioration of the ESR.

It is reported that the separators described in Patent Literature 2 and Patent Literature 3 have high denseness and homogeneity and can contribute to a reduction in short-circuit failure in the capacitors. However, there have been cases where the mechanical strengths, such as tensile strengths or tear strengths, of the separators are weak, and where voids for impregnating and retaining the polymerization liquids or dispersion liquids of the conductive polymers are narrow. Therefore, it has been found that only controlling the average pore size of the separator is not enough to achieve both the impregnation property and retention property of the polymerization liquid or dispersion liquid of the conductive polymer and resistance to short-circuiting.

Patent Literature 4 discloses a separator for an electrochemical element that is a nonwoven fabric containing a fibrillated polymer having a melting point or a thermal decomposition temperature of 250° C. or higher, at least a part of which has a fiber diameter of 1 μm or less, and a weight average fiber length in the range of 0.2-2 mm, and organic fibers having a fineness of 3.3 dtex or less, and that has a volume resistivity of 1×10¹¹ Ω·cm or more. It is reported that, with this configuration, a separator that is dense and has a high volume resistivity is obtained. It is described that an aluminum electrolytic capacitor using this separator has a low internal resistance and excellent high-speed charge/discharge characteristics.

Even in a separator that is dense and capable of reducing the internal resistance of a capacitor, as the separator described in Patent Literature 4, however, the mechanical strength, such as a tensile strength or a tear strength, is weak, and occurrence of a short-circuit failure cannot be suppressed while low ESR is achieved.

Various forces in various directions are applied to the separator at the time of winding an element of the aluminum electrolytic capacitor including the conductive polymer capacitor and inside the wound element after being wound. For example, there are a force applied in a longitudinal direction of the separator (MD direction: a direction of the separator parallel to the traveling direction when the separator is produced with a paper machine), a force that tends to spread from the center portion toward the outer edge portion of an element that is a wound product, a force pressed from irregularities such as burrs of a tab and an electrode foil, and the like. Here, as a measure to increase the withstand voltage of the aluminum electrolytic capacitor, it is known to increase the thickness of an oxide film formed on the surface of an anode foil. As the oxide film becomes thicker, the thickness of the anode foil itself becomes thicker, so that the force to be applied to the separator as described above becomes larger.

In the conventional separators, there has been a problem that, due to application of these various forces in various directions, a partial defect, such as loss of the fiber at a place where the fiber originally existed, occurs because a bond between the fibers constituting the separator is broken, coarse and fine unevenness is created due to movement of the fibers, or the like. It has been found that, due to this defect, separation between the anode foil and the cathode foil is partially insufficient, so that a short-circuit failure occurs.

When the separator is made dense or the bonding area between the fibers is increased in order to suppress the occurrence of the partial defect in the separator as described above, the voids between the fibers constituting the separator are narrowed. Therefore, even if the occurrence of a short-circuit failure in the capacitor can be suppressed, the impregnation property and retention property of the polymerization liquid or dispersion liquid of the conductive polymer are deteriorated, and the deterioration of the ESR cannot be suppressed.

As a result of intensive studies by the inventors of the present invention, it has been found that, in order to achieve both maintaining the impregnation property and retention property of the polymerization liquid or dispersion liquid of the conductive polymer and improving the resistance to short-circuiting of the separator, it is important to increase stability against the various forces in various directions applied to the separator at the time of winding the element and inside the wound element after being wound. That is, by increasing the stability against the various forces in various directions, occurrence of a partial defect can be suppressed.

The present invention has been made in view of the above problems, and an object of the present invention is to improve stability against various forces in various directions applied to a separator at the time of winding an element and inside the wound element after being wound while maintaining the impregnation property and retention property of a polymerization liquid or dispersion liquid of a conductive polymer, thereby suppressing a partial defect to occur in the separator and improving the resistance to short-circuiting of the separator. Another object of the present invention is to suppress occurrence of a short-circuit failure without deteriorating the ESR of a conductive polymer capacitor using the separator more than that of a conventional conductive polymer capacitor.

### Solution to Problem

A separator according to the present invention is made to solve the above problems, and has, for example, the following configuration.

That is, the separator is a separator for an aluminum electrolytic capacitor that is interposed between a pair of electrodes and is used in an aluminum electrolytic capacitor having a conductive polymer as a cathode material, in which the separator includes synthetic fibers and a binder, and has a bursting strength of 40-180 kPa and a burst index of 3.5-7.5 kPa/(g/m²).

The synthetic fibers include, for example, fibrillated synthetic fibers and non-fibrillated synthetic fibers.

For example, the separator contains 70-95 mass % of the synthetic fibers and 5-30 mass % of the binder, and contains 20-70 mass % of the fibrillated synthetic fibers and 10-75 mass % of the non-fibrillated synthetic fibers based on the total mass of the separator.

Furthermore, the separator has a modulus of elasticity of, for example, 500-2000 MPa.

The aluminum electrolytic capacitor of the present invention uses a conductive polymer as a cathode material, and uses the separator of the present invention as a separator.

### Advantageous Effects of Invention

According to the present invention, it is possible, by having a configuration for solving the above problems, to obtain a separator that has stability against the various forces in various directions applied to the separator at the time of winding the element and inside the wound element after being wound while the impregnation property and retention property of a polymerization liquid or dispersion liquid of the conductive polymer are maintained.

The conductive polymer capacitor using the separator of the present invention can suppress occurrence of a short-circuit failure while having low ESR. Furthermore, it can contribute to an increase in the withstand voltage of the conductive polymer capacitor.

### DESCRIPTION OF EMBODIMENTS

Hereinafter, embodiments for carrying out the present invention will be described in detail.

In the present invention, attention is paid to a partial defect in a separator that occurs at the time of winding an element and inside the wound element after being wound, and stability against various forces in various directions applied to the separator at the time of winding the element and inside the wound element after being wound is improved by using synthetic fibers and a binder.

In a conventional separator whose resistance to short-circuiting is increased by improving the denseness and homogeneity of the separator, there is a limit in achieving both low ESR and suppression of occurrence of a short-circuit failure. The separator of the present invention can improve resistance to short-circuiting without impairing the impregnation property and retention property of a polymerization liquid or dispersion liquid of the conductive polymer by improving the stability against the various forces in various directions applied to the separator.

As a result of intensive studies by the inventors of the present invention, it has been found that, by controlling the bursting strength and the burst index of the separator to be within certain ranges, it is possible to increase resistance to short-circuiting without causing a partial defect while maintaining the impregnation property and retention property of the polymerization liquid or dispersion liquid of the conductive polymer. In addition, it has been found that a conductive polymer capacitor using the separator of the present invention can simultaneously achieve low ESR and suppression of occurrence of a short-circuit failure, which has led to the present invention.

In an embodiment for carrying out the present invention, a bursting strength and a burst index obtained by dividing the bursting strength by the basis weight of the separator are used as indices of the stability against the various forces in various directions applied to the separator at the time of winding the element and inside the wound element after being wound.

The bursting strength is different from a mechanical strength occurring when a force in a certain direction is applied, such as a tensile strength or a tear strength, and resistance, occurring when forces are simultaneously applied from a plurality of directions, can be measured. Even a separator having a high mechanical strength in a certain direction, such as a tensile strength or a tear strength, does not necessarily have a high bursting strength. When a force is applied from another direction, a partial defect may occur because a bond between fibers constituting the separator is broken, the fiber moves from a place where it should originally exist, or the like.

The burst index as well as the bursting strength can be used as indices of the strength of the bond between the fibers constituting the separator. Since the burst index represents a bursting strength per basis weight, it is possible to compare degrees of entanglement between the fibers constituting the separator and the magnitudes of the bonding area by comparing the burst indices. It is found that, when the burst index is within a certain range, the degree of the entanglement between the fibers constituting the separator or the bonding area is controlled.

As the entanglements between the fibers are less, or the bonding area is smaller, a partial defect may be more likely to occur because the bond between the fibers constituting the separator is easily broken, the fiber moves from a place where it should originally exist, or the like. Conversely, as the entanglements between the fibers are more, or the bonding area is larger, the polymerization liquid or dispersion liquid of a conductive polymer is less likely to permeate into the separator.

From the above, by controlling a bursting strength and a burst index to be within certain ranges, it is possible to provide a separator that has improved stability against the various forces in various directions applied to the separator at the time of winding the element and inside the wound element after being wound while the impregnation property and retention property of the polymerization liquid or dispersion liquid of the conductive polymer are maintained.

A separator of an embodiment for carrying out the present invention is, for example, a separator for an aluminum electrolytic capacitor that is interposed between a pair of electrodes and is used in an aluminum electrolytic capacitor having a conductive polymer as a cathode material, in which the separator has a bursting strength of 40-180 kPa and a burst index of 3.5-7.5 kPa/(g/m²). Preferably, the bursting strength is controlled to be 50-160 kPa and the burst index to be 4.0-7.0 kPa/(g/m²).

In the separator of the embodiment for carrying out the present invention, by controlling a bursting strength to be 40-180 kPa and a burst index to be 3.5-7.5 kPa/(g/m²), the stability against the various forces in various directions applied to the separator at the time of winding the element and inside the wound element after being wound can be improved. In addition, the separator can have voids between the fibers constituting the separator, the voids being necessary for impregnating and retaining the polymerization liquid or dispersion liquid of the conductive polymer.

As a result, it possible to achieve both maintaining the impregnation property and retention property of the polymerization liquid or dispersion liquid of the conductive polymer and improving resistance to short-circuiting without causing a partial defect in the separator.

If the bursting strength is less than 40 kPa, the separator cannot withstand the various forces in various directions applied to the separator at the time of winding the element and inside the wound element after being wound, and a partial defect occurs in the separator because a bond between the fibers constituting the separator is broken, coarse and fine unevenness is created due to movement of the fibers, or the like. Therefore, separation between an anode foil and a cathode foil becomes insufficient, and for example, the burr of the electrode foil penetrates the separator or a tab compresses and damages the separator, which causes a short-circuit failure.

The upper limit of the bursting strength is 180 kPa as determined from the thickness and density of a separator that can be applied to the conductive polymer capacitor. If the bursting strength is more than 180 kPa, the ESR tends to increase.

If the burst index is less than 3.5 kPa/(g/m²), the bond between the fibers constituting the separator is weaker than that of the separator having a burst index of 3.5 kPa/(g/m²) or more. From this, it is found that the entanglement between the fibers is less, or the bonding area between the fibers is smaller. Therefore, the separator cannot withstand the various forces in various directions applied to the separator at the time of winding the element and inside the wound element after being wound, and the fiber constituting the separator moves and is lost from a place where the fiber originally existed, which causes a partial defect in the separator. As a result, the separation between the anode foil and the cathode foil becomes insufficient, which causes a short-circuit failure.

If the burst index is more than 7.5 kPa/(g/m²), the bond between the fibers constituting the separator is excessively stronger than that of the separator having a burst index of 7.5 kPa/(g/m²) or less. From this, it is found that there are many entanglements between the fibers and the separator become excessively dense, or the bonding area between the fibers is large. Therefore, impregnation with the polymerization liquid or dispersion liquid of the conductive polymer becomes uneven, which deteriorates the ESR.

The separator of an embodiment of the present invention contains synthetic fibers from the viewpoint of chemical stability, and also contains a binder from the viewpoint of mechanical strength.

As the synthetic fiber according to the embodiment of the present invention, any synthetic fiber can be selected as long as the bursting strength and the burst index can be satisfied. Examples of the synthetic fiber to be used include a polyamide fiber, an acrylic fiber, a polyester fiber, and a vinylon fiber from the viewpoints of acid resistance, oxidation resistance, and the impregnation property of the polymerization liquid or dispersion liquid of the conductive polymer.

The synthetic fibers of the embodiment of the present invention preferably include a fibrillated synthetic fiber and a non-fibrillated synthetic fiber in order to increase the denseness and mechanical strength of the separator, and further in order to increase the impregnation property and retention property of the polymerization liquid or dispersion liquid of the conductive polymer.

The fibrillated synthetic fiber refers to a synthetic fiber in which fine fibrils are generated in a foliage pattern from a portion serving as a main body by a treatment such as beating, or a synthetic fiber manufactured in a state of having foliage-shaped fibrils like pulp.

The fibrillated synthetic fiber is preferably a fibrillated polyamide fiber from the viewpoints of heat resistance and chemical resistance. Specifically, a fibrillated aramid fiber is preferable.

The non-fibrillated synthetic fiber refers to a synthetic fiber with no foliage-shaped fibril. The non-fibrillated synthetic fiber may be a fiber containing a single component or a fiber containing a plurality of components, or may have a structure like a composite fiber. As the non-fibrillated synthetic fiber, a polyamide fiber, an acrylic fiber, a polyester fiber, a vinylon fiber, or the like can be used. A polyamide fiber, an acrylic fiber, and a polyester fiber are preferable from the viewpoints of chemical resistance and the impregnation property of the polymerization liquid or dispersion liquid of the conductive polymer.

The binder of the embodiment of the present invention is used for bonding between the fibers constituting the separator. Any binder can be selected as long as the bursting strength and the burst index can be satisfied. Furthermore, the binder forms a film, so that it is difficult for the burr of the electrode foil to penetrate the separator, it is difficult for the tab to compress and damage the separator, and the like, which can improve the resistance to short-circuiting of the separator. The film herein refers to a film-shaped object existing at entanglement points of the fibers constituting the separator or between the fibers, the object having been formed by the binder under wet heat conditions.

From the fact that the mechanical strength is improved and the film can be easily formed, it is preferable to use polyvinyl alcohol or a vinyl alcohol copolymer as the binder.

In addition, as a configuration of the separator according to the embodiment of the present invention, it is preferable that the separator contains 70-95 mass % of the synthetic fibers and 5-30 mass % of the binder, and contains 20-70 mass % of the fibrillated synthetic fibers and 10-75 mass % of the non-fibrillated synthetic fibers based on the total mass of the separator.

If the amount of the synthetic fibers is less than 70 mass % and the amount of the binder is more than 30 mass %, the ESR of the conductive polymer capacitor may be deteriorated. It is considered that, when the amount of the binder is increased, the area of the film to be formed is increased and the voids between the fibers constituting the separator are excessively filled, so that the impregnation property and retention property of the polymerization liquid or dispersion liquid of the conductive polymer are deteriorated.

If the amount of the synthetic fibers is more than 95 mass % and the amount of the binder is less than 5 mass %, the mechanical strength of the separator is low and the resistance to short-circuiting cannot be increased, so that occurrence of a short-circuit failure in the conductive polymer capacitor may not be suppressed.

If the amount of the fibrillated synthetic fibers is less than 20 mass % and the amount of the non-fibrillated synthetic fibers is more than 75 mass %, the denseness of the separator tends to be low, so that it is difficult to obtain the effect of suppressing occurrence of a short-circuit failure in the separator. In addition, the denseness is low, so that the retention amount of the conductive polymer tends to decrease and the ESR is difficult to be reduced.

On the other hand, if the amount of the fibrillated synthetic fibers is more than 70 mass % and the amount of the non-fibrillated synthetic fibers is less than 10 mass %, the denseness of the separator tends to be high and the impregnation with the polymerization liquid or dispersion liquid of the conductive polymer tends to be uneven, so that the ESR characteristics tend to vary.

For example, when the fibrillated synthetic fibers having a length-weighted mean length in the range of 0.3-2.0 mm are contained in an amount of 20-70 mass %, the non-fibrillated synthetic fibers having a fiber length in the range of 1.5-6.5 mm are contained in an amount of 10-75 mass %, and the binder is contained in an amount of 5-30 mass %, the bursting strength and the burst index can be controlled to be within certain ranges, so that the separator of the present invention can be obtained.

If the fiber lengths are smaller than the above values, there is a concern that the tensile strength may be insufficient. If the fiber lengths are larger than the above values, there is a concern that the homogeneity of the texture of the separator or the like may be impaired.

In the present invention, a modulus of elasticity is used as an index of the stretchability of the separator. The modulus of elasticity can indicate ease of deformation in an elastic deformation region, in which as the modulus of elasticity is lower, the separator is more likely to stretch and deform with a weak force. In addition, as the modulus of elasticity is higher, a stronger force is required to reach a deformation.

The modulus of elasticity of the separator of the present invention is preferably 500-2000 MPa. When the modulus of elasticity is within the range of 500-2000 MPa, the separator has moderate stretchability, and can exhibit flexible responsiveness to the various forces in various directions applied to the separator at the time of winding the element and inside the wound element after being wound. As a result, followability to the electrode foil is improved, and a separator having high adhesion to the electrode foil can be obtained. As a result, the continuity of the formed conductive polymer can be maintained at the interface between the electrode foil and the separator, so that the ESR of the conductive polymer capacitor can be reduced.

If the modulus of elasticity is less than 500 MPa, the separator is easily deformed by the various forces in various directions applied to the separator at the time of winding the element and inside the wound element after being wound. Therefore, a state is created in which the electrode foil and the separator are in excessively close contact with each other, and the separator acts like a sealing material. As a result, the impregnation with the polymerization liquid or dispersion liquid of the conductive polymer becomes uneven, so that the effect of reducing the ESR of the conductive polymer capacitor may not be obtained.

If the modulus of elasticity is more than 2000 MPa, the stretchability of the separator is low, so that the adhesion to the electrode foil is deteriorated. As a result, the continuity of the conductive polymer is impaired at the interface between the electrode foil and the separator, so that the effect of reducing the ESR of the conductive polymer capacitor may not be obtained.

As the thickness and density of the separator according to the embodiment for carrying out the present invention, those that satisfy desired characteristics of the conductive polymer capacitor can be adopted without particular limitation. As the separator for a conductive polymer capacitor, a separator having a thickness of 20-100 μm and a density of about 0.20-0.60 g/cm³ is generally used, but the separator is not limited to these ranges.

The method for producing the separator is not particularly limited, but from the viewpoint of the homogeneity of the texture of the separator or the like, a papermaking method is preferable in which fibers dispersed in water are deposited on a wire and the fibers are dehydrated and dried to make a sheet.

In an embodiment for carrying out the present invention, a wet nonwoven fabric formed using the papermaking method is adopted as the separator. The papermaking mode for the separator is not particularly limited as long as the bursting strength and the burst index can be satisfied, and papermaking modes, such as fourdrinier papermaking, tanmo papermaking, and cylinder papermaking, can be adopted. An object obtaining by combining a plurality of layers each formed by one of these papermaking methods may also be adopted. In the papermaking, additives, such as a dispersant, an antifoaming agent, and a paper strength enhancer, may be added as long as the impurity contents thereof do not affect the separator for a conductive polymer capacitor. A post-treatment, such as a paper strength enhancement treatment, a lyophilic treatment, a calender treatment, or an emboss treatment, may also be performed after a paper layer is formed.

By adopting the above configurations, the separator of an embodiment for carrying out the present invention has stability against the various forces in various directions applied to the separator at the time of winding the element and inside the wound element after being wound while maintaining the good impregnation property and retention property of the polymerization liquid or dispersion liquid of the conductive polymer. The separator can have increased resistance to short-circuiting without causing a partial defect therein. The conductive polymer capacitor using the separator can suppress occurrence of a short-circuit failure while having low ESR. Eventually, this contributes to an increase in the withstand voltage of the conductive polymer capacitor.

### [Method for Measuring Characteristics of Separator and Conductive Polymer Capacitor]

Specific measurement of each characteristic of the separator and the conductive polymer capacitor of the present embodiment was performed under the following conditions and methods.

### [Thickness]

The thickness of the separator was measured by a method in which the separator was folded into 10 sheets in a way described in “5.1.3 Case of measuring thickness by folding paper” specified in “JIS C 2300-2 ‘Cellulosic papers for electrical purposes—Part 2: Methods of test’ 5.1 Thickness” using a micrometer of “5.1.1 Measuring instrument and measuring method: a Case of using outside micrometer”.

### [Density]

The density of the separator in a bone dry condition was measured by a method specified in Method B of “JIS C 2300-2 ‘Cellulosic papers for electrical purposes—Part 2: Method of test’ 7.0 A Density”.

### [Bursting Strength]

The bursting strength of the separator was measured by the method specified in “JIS C 2300-2 ‘Cellulosic papers for electrical purposes—Part 2: Methods of test’ 11 Bursting strength”.

### [Burst Index]

The burst index was calculated by dividing the value of the bursting strength measured by the above test method by the basis weight of the separator measured by the method specified in “JIS C 2300-2 ‘Cellulosic papers for electrical purposes—Part 2: Methods of test’ 6 Basis weight”.

### [Modulus of Elasticity]

The modulus of elasticity in the longitudinal direction (MD direction) of the separator was measured by the method specified in “JIS P 8113 ‘Paper and board—Determination of tensile properties—Part 2: Constant rate of elongation method”.

### [Length-Weighted Mean Length of Fibrillated Synthetic Fiber]

A length-weighted mean length was measured by using the device described in “JIS P 8226-2 ‘Pulps—Determination of Fibre length by automated optical analysis—Part 2: Unpolarized light method (ISO 16065-2)’, here, Fiber Tester PLUS (manufactured by Lorentzen & Wettre). The measured length-weighted mean length was defined as the fiber length of the fibrillated synthetic fiber.

### [Fiber Length of Non-Fibrillated Synthetic Fiber]

Various commercially available non-fibrillated synthetic fibers were purchased, and the cut length thereof was defined as the fiber length of the non-fibrillated synthetic fiber.

### [Production Process of Solid Electrolytic Capacitor]

Two types of solid electrolytic capacitors were produced by using the separators of the following Examples, Comparative Examples, and Conventional Examples, in which each of the capacitors had a diameter of 10.0 mm and a height of 10.0 mm, one type of the two had a rated voltage of 35 V and an electrostatic capacitance of 150 μF, and the other type had a rated voltage of 80 V and an electrostatic capacitance of 22 μF.

The specific production process is as follows.

An anode foil having a thickness of 115 μm and a cathode foil having a thickness of 50 μm, each of which had been subjected to an etching treatment and an oxide film formation treatment, were wound with the separator interposed therebetween so as not to come into contact with each other. The outer circumference of the wound element was fixed with a tape to produce a capacitor element. The produced capacitor element was subjected to a re-chemical conversion treatment and then dried.

In the solid electrolytic capacitor having a rated voltage of 35 V, the capacitor element was impregnated with a polymerization liquid of a conductive polymer, and then the liquid was heated and polymerized to dry a solvent, thereby forming a conductive polymer layer. For the polymerization liquid of the conductive polymer, 3,4-ethylenedioxythiophene was used as a monomer, and an iron p-toluenesulfonate solution was used as an oxidant solution.

In the solid electrolytic capacitor having a rated voltage of 80 V, the capacitor element was impregnated with a dispersion liquid of a conductive polymer, and then the liquid was heated and dried to form a conductive polymer layer. As the dispersion liquid of the conductive polymer, a dispersion liquid, containing, as a dispersoid, PEDOT/PSS (a composite containing poly(3,4-ethylenedioxythiophene) and polystyrene sulfonic acid), was used.

Next, the capacitor element was placed in a predetermined case, the opening was sealed, and then aging was performed to obtain each solid electrolytic capacitor.

### [Production Process of Hybrid Electrolytic Capacitor]

Two types of hybrid electrolytic capacitors were produced by using the separators of Examples, Comparative Examples, and Conventional Examples, in which each of the capacitors had a diameter of 10.0 mm and a height of 10.5 mm, one type of the two had a rated voltage of 35 V and an electrostatic capacitance of 270 μF, and the other type had a rated voltage of 160 V and an electrostatic capacitance of 6.8 μF.

The specific production process is as follows.

An anode foil having a thickness of 115 μm and a cathode foil having a thickness of 50 μm, each of which had been subjected to an etching treatment and an oxide film formation treatment, were wound with the separator interposed therebetween so as not to come into contact with each other. The outer circumference of the wound element was fixed with a tape to produce a capacitor element. The produced capacitor element was subjected to a re-chemical conversion treatment and then dried.

In the hybrid electrolytic capacitor having a rated voltage of 35 V, the capacitor element was impregnated with the polymerization liquid of the conductive polymer, and then the liquid was heated and polymerized to dry a solvent, thereby forming a conductive polymer layer. For the polymerization liquid of the conductive polymer, 3,4-ethylenedioxythiophene was used as a monomer, and an iron p-toluenesulfonate solution was used as an oxidant solution.

In the hybrid electrolytic capacitor having a rated voltage of 160 V, the capacitor element was impregnated with the dispersion liquid of the conductive polymer, and then the liquid was heated and dried to form a conductive polymer layer. As the dispersion liquid of the conductive polymer, a dispersion liquid, containing, as a dispersoid, PEDOT/PSS (a composite containing poly(3,4-ethylenedioxythiophene) and polystyrene sulfonic acid), was used.

Subsequently, the capacitor element was impregnated with a driving electrolytic solution and placed in a predetermined case, the opening was sealed, and then aging was performed to obtain each hybrid electrolytic capacitor.

### [Method for Evaluating Conductive Polymer Capacitor]

Specific performance evaluation of the conductive polymer capacitor of the present embodiment was performed under the following conditions and methods.

### [Short-Circuit Failure Rate]

A thousand wound capacitor elements were prepared, the number of short-circuit failures occurring during aging was counted, the number of the elements, in each of which the short-circuit failure occurred, was divided by the number of the capacitor elements subjected to the aging, and the percentage was defined as a short-circuit failure rate.

### [ESR]

The ESR of the produced capacitor element was measured using an LCR meter under conditions of a temperature of 20° C. and a frequency of 100 kHz.

### EXAMPLES

Hereinafter, specific examples and the like of the separator according to the embodiment of the present invention will be described.

### Example 1

A raw material, obtained by mixing 60 mass % of fibrillated acrylic fibers (length-weighted mean length of 0.8 mm), 30 mass % of aramid fibers (fiber length of 2.0 mm), and 10 mass % of polyvinyl alcohol, was used for cylinder papermaking to obtain a separator of Example 1.

The thickness of the completed separator of Example 1 was 50 μm, the density was 0.55 g/cm³, the bursting strength was 120 kPa, the burst index was 4.4 kPa/(g/m²), and the modulus of elasticity was 2030 MPa.

### Example 2

A raw material, obtaining by mixing 45 mass % of fibrillated polyester fibers (length-weighted mean length of 0.5 mm), 50 mass % of vinylon fibers (fiber length of 5.0 mm), and 5 mass % of an ethylene vinyl alcohol copolymer, was used for cylinder papermaking to obtain a separator of Example 2.

The thickness of the completed separator of Example 2 was 20 μm, the density was 0.45 g/cm³, the bursting strength was 52 kPa, the burst index was 5.8 kPa/(g/m²), and the modulus of elasticity was 480 MPa.

### Example 3

A raw material, obtained by mixing 60 mass % of fibrillated aramid fibers (length-weighted mean length of 0.4 mm), 10 mass % of acrylic fibers (fiber length of 5.0 mm), and 30 mass % of polyvinyl alcohol, was used for cylinder papermaking to obtain a separator of Example 3.

The thickness of the completed separator of Example 3 was 50 μm, the density was 0.60 g/cm³, the bursting strength was 178 kPa, the burst index was 5.9 kPa/(g/m²), and the modulus of elasticity was 1320 MPa.

### Example 4

A raw material, obtained by mixing 70 mass % of fibrillated aramid fibers (length-weighted mean length of 0.8 mm), 10 mass % of nylon fibers (fiber length of 3.0 mm), and 20 mass % of polyvinyl alcohol, was used for cylinder papermaking to obtain a separator of Example 4.

The thickness of the completed separator of Example 4 was 40 μm, the density was 0.50 g/cm³, the bursting strength was 135 kPa, the burst index was 6.8 kPa/(g/m²), and the modulus of elasticity was 1710 MPa.

### Example 5

A raw material, obtained by mixing 45 mass % of fibrillated acrylic fibers (length-weighted mean length of 1.2 mm), 30 mass % of nylon fibers (fiber length of 3.0 mm), and 25 mass % of polyvinyl alcohol, was used for cylinder papermaking to obtain a separator of Example 5.

The thickness of the completed separator of Example 5 was 80 μm, the density was 0.40 g/cm³, the bursting strength was 155 kPa, the burst index was 4.8 kPa/(g/m²), and the modulus of elasticity was 1620 MPa.

### Example 6

A raw material, obtained by mixing 30 mass % of fibrillated aramid fibers (length-weighted mean length of 1.8 mm), 40 mass % of polyester fibers (fiber length of 3.0 mm), and 30 mass % of polyvinyl alcohol, was used for cylinder papermaking to obtain a separator of Example 6.

The thickness of the completed separator of Example 6 was 100 μm, the density was 0.45 g/cm³, the bursting strength was 163 kPa, the burst index was 3.6 kPa/(g/m²), and the modulus of elasticity was 870 MPa.

### Example 7

A raw material, obtained by mixing 45 mass % of fibrillated aramid fibers (length-weighted mean length of 0.6 mm), 40 mass % of acrylic fibers (fiber length of 3.0 mm), and 15 mass % of polyvinyl alcohol, was used for cylinder papermaking to obtain a separator of Example 7.

The thickness of the completed separator of Example 7 was 50 μm, the density was 0.35 g/cm³, the bursting strength was 100 kPa, the burst index was 5.7 kPa/(g/m²), and the modulus of elasticity was 1270 MPa.

### Example 8

A raw material, obtained by mixing 20 mass % of fibrillated aramid fibers (length-weighted mean length of 0.3 mm), 50 mass % of acrylic fibers (fiber length of 2.0 mm), and 30 mass % of an ethylene vinyl alcohol copolymer, was used for cylinder papermaking to obtain a separator of Example 8.

The thickness of the completed separator of Example 8 was 45 μm, the density was 0.35 g/cm³, the bursting strength was 116 kPa, the burst index was 7.4 kPa/(g/m²), and the modulus of elasticity was 1112 MPa.

### Example 9

A raw material, obtained by mixing 30 mass % of fibrillated acrylic fibers (length-weighted mean length of 1.4 mm), 50 mass % of aramid fibers (fiber length of 4.0 mm), and 20 mass % of an ethylene vinyl alcohol copolymer, was used for cylinder papermaking to obtain a separator of Example 9.

The thickness of the completed separator of Example 9 was 70 μm, the density was 0.40 g/cm³, the bursting strength was 117 kPa, the burst index was 4.2 kPa/(g/m²), and the modulus of elasticity was 1960 MPa.

### Example 10

A raw material, obtained by mixing 20 mass % of fibrillated polyester fibers (length-weighted mean length of 1.6 mm), 75 mass % of acrylic fibers (fiber length of 6.0 mm), and 5 mass % of polyvinyl alcohol, was used for cylinder papermaking to obtain a separator of Example 10.

The thickness of the completed separator of Example 10 was 40 μm, the density was 0.20 g/cm³, the bursting strength was 41 kPa, the burst index was 5.1 kPa/(g/m²), and the modulus of elasticity was 533 MPa.

### Comparative Example 1

A raw material, obtained by mixing 65 mass % of fibrillated aramid fibers (length-weighted mean length of 0.4 mm), 5 mass % of acrylic fibers (fiber length of 5.0 mm), and 30 mass % of polyvinyl alcohol, was used for cylinder papermaking to obtain a separator of Comparative Example 1.

The thickness of the completed separator of Comparative Example 1 was 40 μm, the density was 0.50 g/cm³, the bursting strength was 158 kPa, the burst index was 7.9 kPa/(g/m²), and the modulus of elasticity was 1420 MPa.

### Comparative Example 2

A raw material, obtained by mixing 75 mass % of fibrillated aramid fibers (length-weighted mean length of 0.3 mm), 10 mass % of nylon fibers (fiber length of 2.0 mm), and 15 mass % of polyvinyl alcohol, was used for cylinder papermaking to obtain a separator of Comparative Example 2.

The thickness of the completed separator of Comparative Example 2 was 60 μm, the density was 0.60 g/cm³, the bursting strength was 121 kPa, the burst index was 3.4 kPa/(g/m²), and the modulus of elasticity was 1750 MPa.

### Comparative Example 3

A raw material, obtained by mixing 25 mass % of fibrillated acrylic fibers (length-weighted mean length of 1.9 mm), 40 mass % of polyester fibers (fiber length of 3.0 mm), and 35 mass % of polyvinyl alcohol, was used for cylinder papermaking to obtain a separator of Comparative Example 3.

The thickness of the completed separator of Comparative Example 3 was 80 μm, the density was 0.35 g/cm³, the bursting strength was 187 kPa, the burst index was 6.7 kPa/(g/m²), and the modulus of elasticity was 570 MPa.

### Comparative Example 4

A raw material, obtained by mixing 15 mass % of fibrillated aramid fibers (length-weighted mean length of 0.5 mm), 60 mass % of acrylic fibers (fiber length of 2.0 mm), and 25 mass % of an ethylene vinyl alcohol copolymer, was used for cylinder papermaking to obtain a separator of Comparative Example 4.

The thickness of the completed separator of Comparative Example 4 was 35 μm, the density was 0.35 g/cm³, the bursting strength was 94 kPa, the burst index was 7.7 kPa/(g/m²), and the modulus of elasticity was 980 MPa.

### Comparative Example 5

A raw material, obtained by mixing 15 mass % of fibrillated acrylic fibers (length-weighted mean length of 0.9 mm), 80 mass % of acrylic fibers (fiber length of 6.0 mm), and 5 mass % of polyvinyl alcohol, was used for cylinder papermaking to obtain a separator of Comparative Example 5.

The thickness of the completed separator of Comparative Example 5 was 50 μm, the density was 0.30 g/cm³, the bursting strength was 43 kPa, the burst index was 2.9 kPa/(g/m²), and the modulus of elasticity was 2060 MPa.

### Comparative Example 6

A raw material, obtained by mixing 45 mass % of fibrillated polyester fibers (length-weighted mean length of 0.4 mm), 52 mass % of vinylon fibers (fiber length of 3.0 mm), and 3 mass % of an ethylene vinyl alcohol copolymer, was used for cylinder papermaking to obtain a separator of Comparative Example 6.

The thickness of the completed separator of Comparative Example 6 was 20 μm, the density was 0.45 g/cm³, the bursting strength was 35 kPa, the burst index was 3.9 kPa/(g/m²), and the modulus of elasticity was 460 MPa.

### Conventional Example 1

A separator to be manufactured by the same method as that described in Example 1 of Patent Literature 1 was produced to obtain a separator of Conventional Example 1.

The thickness of the separator of Conventional Example 1 was 45 μm, the density was 0.36 g/cm³, the bursting strength was 46 kPa, the burst index was 2.8 kPa/(g/m²), and the modulus of elasticity was 720 MPa.

### Conventional Example 2

A separator to be manufactured by the same method as that described in Example 1 of Patent Literature 2 was produced to obtain a separator of Conventional Example 2.

The thickness of the separator of Conventional Example 2 was 30 μm, the density was 0.55 g/cm³, the bursting strength was 54 kPa, the burst index was 3.3 kPa/(g/m²), and the modulus of elasticity was 1560 MPa.

### Conventional Example 3

A separator to be manufactured by the same method as that described in Example 1 of Patent Literature 3 was produced to obtain a separator of Conventional Example 3.

The thickness of the separator of Conventional Example 3 was 60 μm, the density was 0.20 g/cm³, the bursting strength was 94 kPa, the burst index was 7.8 kPa/(g/m²), and the modulus of elasticity was 540 MPa.

### Conventional Example 4

A separator to be manufactured by the same method as that described in Example 1 of Patent Literature 4 was produced to obtain a separator of Conventional Example 4.

The thickness of the separator of Conventional Example 4 was 55 μm, the density was 0.33 g/cm³, the bursting strength was 37 kPa, the burst index was 2.0 kPa/(g/m²), and the modulus of elasticity was 630 MPa.

The raw materials and blending of the separators of Examples 1-10, Comparative Examples 1-6, and Conventional Examples 1-4 described above are shown in Table 1.

TABLE 1

| | Separator material | | | | | | |
|---|---|---|---|---|---|---|---|
| | Synthetic fiber | | | | Binder | | Cellulose |
| | Raw | Mass | Raw | Mass | Raw | Mass | Mass |
| | material | % | material | % | material | % | % |
| Example 1 | Fibrillated | 60 | Aramid | 30 | Polyvinyl | 10 | — |
| | acrylic | | | | alcohol | | |
| Example 2 | Fibrillated | 45 | Vinylon | 50 | Ethylene vinyl | 5 | — |
| | polyester | | | | alcohol copolymer | | |
| Example 3 | Fibrillated | 60 | Acrylic | 10 | Polyvinyl | 30 | — |
| | aramid | | | | alcohol | | |
| Example 4 | Fibrillated | 70 | Nylon | 10 | Polyvinyl | 20 | — |
| | aramid | | | | alcohol | | |
| Example 5 | Fibrillated | 45 | Nylon | 30 | Polyvinyl | 25 | — |
| | acrylic | | | | alcohol | | |
| Example 6 | Fibrillated | 30 | Polyester | 40 | Polyvinyl | 30 | — |
| | aramid | | | | alcohol | | |
| Example 7 | Fibrillated | 45 | Acrylic | 40 | Polyvinyl | 15 | — |
| | aramid | | | | alcohol | | |
| Example 8 | Fibrillated | 20 | Acrylic | 50 | Ethylene vinyl | 30 | — |
| | aramid | | | | alcohol copolymer | | |
| Example 9 | Fibrillated | 30 | Aramid | 50 | Ethylene vinyl | 20 | — |
| | acrylic | | | | alcohol copolymer | | |
| Example 10 | Fibrillated | 20 | Acrylic | 75 | Polyvinyl | 5 | — |
| | polyester | | | | alcohol | | |
| Comparative | Fibrillated | 65 | Acrylic | 5 | Polyvinyl | 30 | — |
| Example 1 | aramid | | | | alcohol | | |
| Comparative | Fibrillated | 75 | Nylon | 10 | Polyvinyl | 15 | — |
| Example 2 | aramid | | | | alcohol | | |
| Comparative | Fibrillated | 25 | Polyester | 40 | Polyvinyl | 35 | — |
| Example 3 | acrylic | | | | alcohol | | |
| Comparative | Fibrillated | 15 | Acrylic | 60 | Ethylene vinyl | 25 | — |
| Example 4 | aramid | | | | alcohol copolymer | | |
| Comparative | Fibrillated | 15 | Acrylic | 80 | Polyvinyl | 5 | — |
| Example 5 | acrylic | | | | alcohol | | |
| Comparative | Fibrillated | 45 | Vinylon | 52 | Ethylene vinyl | 3 | — |
| Example 6 | polyester | | | | alcohol copolymer | | |
| Conventional | Fibrillated | 30 | Polyester | 70 | — | — | — |
| Example 1 | aramid | | | | | | |
| Conventional | Fibrillated | 50 | Acrylic | 50 | — | — | — |
| Example 2 | acrylic | | | | | | |
| Conventional | — | — | Polyester | 70 | Polyvinyl | 30 | — |
| Example 3 | | | | | alcohol | | |
| Conventional | Fibrillated | 25 | Polyester | 60 | — | — | 15 |
| Example 4 | aramid | | | | | | |

Table 2 shows evaluation results of the separators of Examples 1-10, Comparative Examples 1-6, and Conventional Examples 1-4 described above.

TABLE 2

| | Separator characteristics | | | | |
|---|---|---|---|---|---|
| | | | | Burst | Modulus |
| | Thick- | | Bursting | index | of |
| | ness | Density | strength | kPa/ | elasticity |
| | μm | (g/m³) | kPa | (g/m²) | MPa |
| Example 1 | 50 | 0.55 | 120 | 4.4 | 2030 |
| Example 2 | 20 | 0.45 | 52 | 5.8 | 480 |
| Example 3 | 50 | 0.60 | 178 | 5.9 | 1320 |
| Example 4 | 40 | 0.50 | 135 | 6.8 | 1710 |
| Example 5 | 80 | 0.40 | 155 | 4.8 | 1620 |
| Example 6 | 100 | 0.45 | 163 | 3.6 | 870 |
| Exemple 7 | 50 | 0.35 | 100 | 5.7 | 1270 |
| Example 8 | 45 | 0.35 | 116 | 7.4 | 1112 |
| Example 9 | 70 | 0.40 | 117 | 4.2 | 1960 |
| Example 10 | 40 | 0.20 | 41 | 5.1 | 533 |
| Comparative | 40 | 0.50 | 158 | 7.9 | 1420 |
| Example 1 | | | | | |
| Comparative | 60 | 0.60 | 121 | 3.4 | 1750 |
| Example 2 | | | | | |
| Comparative | 80 | 0.35 | 187 | 6.7 | 570 |
| Example 3 | | | | | |
| Comparative | 35 | 0.35 | 94 | 7.7 | 980 |
| Example 4 | | | | | |
| Comparative | 50 | 0.30 | 43 | 2.9 | 2060 |
| Example 5 | | | | | |
| Comparative | 20 | 0.45 | 35 | 3.9 | 460 |
| Example 6 | | | | | |
| Conventional | 45 | 0.36 | 46 | 2.8 | 720 |
| Example 1 | | | | | |
| Conventional | 30 | 0.55 | 54 | 3.3 | 1560 |
| Example 2 | | | | | |
| Conventional | 60 | 0.20 | 94 | 7.8 | 540 |
| Example 3 | | | | | |
| Conventional | 55 | 0.33 | 37 | 2.0 | 630 |
| Example 4 | | | | | |

Conductive polymer capacitors produced using the separators of Examples, Comparative Examples, and Conventional Examples will be described. By using the separators of Examples, Comparative Examples, and Conventional Examples, solid electrolytic capacitors having a rated voltage of 35 V and a capacitance of 150 μF, those having a rated voltage of 80 V and an electrostatic capacitance of 22 μF, hybrid electrolytic capacitors having a rated voltage of 35 V and an electrostatic capacitance of 270 μF, and those having a rated voltage of 160 V and an electrostatic capacitance of 6.8 μF were produced. Evaluation results of the performance of each of the capacitors are shown in Table 3.

TABLE 3

| | Evaluation results of solid | | | | Evaluation results of hybrid | | | |
|---|---|---|---|---|---|---|---|---|
| | electrolytic capacitors | | | | electrolytic capacitors | | | |
| | Rated | | Rated | | Rated | | Rated | |
| | voltage: 35 V | | voltage: 80 V | | voltage: 35 V | | voltage: 160 V | |
| | Electrostatic | | Electrostatic | | Electrostatic | | Electrostatic | |
| | capacitance: | | capacitance: | | capacitance: | | capacitance: | |
| | 150 μF | | 22 μF | | 270 μF | | 6.8 μF | |
| | Short-circuit | | Short-circuit | | Short-circuit | | Short-circuit | |
| | failure rate | ESR | failure rate | ESR | failure rate | ESR | failure rate | ESR |
| | % | mΩ | % | mΩ | % | mΩ | % | mΩ |
| Example 1 | 0.0 | 21 | 0.0 | 32 | 0.0 | 28 | 0.0 | 43 |
| Example 2 | 0.0 | 20 | 0.0 | 30 | 0.0 | 27 | 0.1 | 43 |
| Example 3 | 0.0 | 18 | 0.0 | 28 | 0.0 | 23 | 0.0 | 39 |
| Example 4 | 0.0 | 13 | 0.0 | 22 | 0.0 | 18 | 0.0 | 33 |
| Example 5 | 0.0 | 15 | 0.0 | 24 | 0.0 | 19 | 0.0 | 34 |
| Example 6 | 0.0 | 15 | 0.2 | 23 | 0.0 | 19 | 0.3 | 35 |
| Example 7 | 0.0 | 12 | 0.0 | 21 | 0.0 | 16 | 0.0 | 31 |
| Example 8 | 0.0 | 18 | 0.0 | 27 | 0.0 | 22 | 0.0 | 37 |
| Example 9 | 0.0 | 14 | 0.1 | 23 | 0.0 | 17 | 0.1 | 32 |
| Example 10 | 0.1 | 12 | 0.3 | 22 | 0.0 | 17 | 0.3 | 31 |
| Comparative | 0.0 | 37 | 0.0 | 43 | 0.0 | 39 | 0.0 | 52 |
| Example 1 | | | | | | | | |
| Comparative | 1.0 | 34 | 2.1 | 41 | 1.0 | 37 | 2.2 | 52 |
| Example 2 | | | | | | | | |
| Comparative | 0.0 | 46 | 0.0 | 55 | 0.0 | 47 | 0.0 | 63 |
| Example 3 | | | | | | | | |
| Comparative | 0.2 | 36 | 1.0 | 42 | 0.3 | 38 | 1.3 | 61 |
| Example 4 | | | | | | | | |
| Comparative | 1.2 | 32 | 2.0 | 40 | 1.1 | 36 | 2.6 | 61 |
| Example 5 | | | | | | | | |
| Comparative | 1.6 | 23 | 3.2 | 34 | 1.7 | 30 | 3.7 | 46 |
| Example 6 | | | | | | | | |
| Conventional | 1.2 | 21 | 2.1 | 32 | 1.1 | 28 | 2.7 | 45 |
| Example 1 | | | | | | | | |
| Conventional | 1.0 | 20 | 1.9 | 31 | 1.0 | 28 | 2.4 | 43 |
| Example 2 | | | | | | | | |
| Conventional | 0.7 | 37 | 1.3 | 42 | 0.6 | 39 | 1.8 | 52 |
| Example 3 | | | | | | | | |
| Conventional | 1.6 | 31 | 2.8 | 42 | 1.4 | 36 | 3.2 | 53 |
| Example 4 | | | | | | | | |

Hereinafter, the evaluation results of the conductive polymer capacitors using the separators of Examples, Comparative Examples, and Conventional Examples will be described in detail.

The ESRs of the capacitors using the separators of Example 1 and Example 2 are comparable to those of the capacitors using the separators of Conventional Examples 1 to 4, but the short-circuit failure rates are lower.

The short-circuit failure rates of the capacitors using the separators of Example 3-10 are comparable to those of the capacitors using the separators of Example 1 and Example 2, but the ESRs are lower.

It can be considered that the ESRs of the separators of Example 3-10 are reduced because the moduli of elasticity of the separators are 533-1960 MPa, the adhesions to the electrode foils are good, and the continuities of the conductive polymers can be maintained at the interfaces between the electrode foils and the separators.

From this, it is found that, when the separator has moderate stretchability, the ESR can be reduced. That is, it has been revealed that, when the modulus of elasticity of the separator is in the range of 500-2000 MPa, the ESR of the conductive polymer capacitor can be reduced.

The thickness, density, and bursting strength of the separator of Comparative Example 1 are comparable to those in Examples, but the burst index is 7.9 kPa/(g/m²), which is higher than those in Examples. The ESRs of the capacitors using the separator of Comparative Example 1 are higher than those in Examples.

It can be considered that the ESRs of the capacitors using the separator of Comparative Example 1 are increased because the burst index of the separator is as high as 7.9 kPa/(g/m²) and the bond between the fibers constituting the separator is excessively strong. It can be considered that, because of having a content of the non-fibrillated synthetic fibers of 5 mass %, the separator of Comparative Example 1 is excessively dense, the burst index is excessively high, and the impregnation with the polymerization liquid or dispersion liquid of the conductive polymer is uneven.

From this, it has been revealed that, when the burst index of the separator is 7.5 kPa/(g/m²) or less, the ESR of the conductive polymer capacitor can be reduced. It is also found that, by controlling the content of the non-fibrillated synthetic fibers to be 10 mass % or more, the impregnation property of the polymerization liquid or dispersion liquid of the conductive polymer can be maintained.

The thickness, density, and bursting strength of the separator of Comparative Example 2 are comparable to those in Examples, but the burst index is 3.4 kPa/(g/m²), which is lower than those in Examples. The short-circuit failure rates of the capacitors using the separator of Comparative Example 2 are higher than those in Examples. The ESRs are slightly higher than those in Conventional Examples.

It can be considered that the shot-circuit failure rates of the capacitors using the separator of Comparative Example 2 are increased because the burst index of the separator is as low as 3.4 kPa/(g/m²) and the bond between the fibers constituting the separator is weak. It can be considered that, because the burst index is low, the separator cannot withstand the various forces in various directions applied to the separator at the time of winding the element and inside the wound element after being wound and a partial defect occurs in the separator, so that a short-circuit failure occurs. It can also be considered that the ESRs of the capacitors using the separator of Comparative Example 2 are increased because the content of the fibrillated aramid is 75 mass %.

From this, it has been revealed that, when the burst index is 3.5 kPa/(g/m²) or more, occurrence of a short-circuit failure can be suppressed in the conductive polymer capacitor. It is also found that, by controlling the content of the fibrillated synthetic fibers to be 70 mass % or less, deterioration of the ESR can be suppressed.

The thickness, density, and burst index of the separator of Comparative Example 3 are comparable to those in Examples, but the bursting strength is 187 kPa, which is higher than those in Examples. The ESRs of the capacitors using the separator of Comparative Example 3 are higher than those in Examples.

It can be considered that the ESRs of the capacitors using the separator of Comparative Example 3 are increased because the bursting strength of the separator is as high as 187 kPa. It can be considered that, because of having a content of polyvinyl alcohol of 35 mass %, the separator of Comparative Example 3 has an excessively high bursting strength and the voids between the fibers constituting the separator are filled. Therefore, it can be considered that, in the separator of Comparative Example 3, the impregnation property and retention property of the polymerization liquid or dispersion liquid of the conductive polymer are deteriorated.

From this, it is found that, when the bursting strength is more than 180 kPa, the ESR is deteriorated. That is, it has been revealed that, when the bursting strength of a separator is 180 kPa or less, the separator can be applied to the conductive polymer capacitor and the ESR can be reduced. It is also found that, by controlling the content of the binder to be 30 mass % or less, voids between the fibers constituting the separator, the voids being necessary for impregnating and retaining the polymerization liquid or dispersion liquid of the conductive polymer, can be provided and the ESR can be reduced.

The thickness, density, and bursting strength of the separator of Comparative Example 4 are comparable to those in Examples, but the burst index is as high as 7.7 kPa/(g/m²). The ESRs of the capacitors using the separator of Comparative Example 4 are higher than those in Examples. In addition, the short-circuit failure rates of the solid electrolytic capacitors having a rated voltage of 80 V and the hybrid electrolytic capacitors having a rated voltage of 160 V are high.

It can be considered that the ESRs of the capacitor using the separator of Comparative Example 4 are increased because the burst index of the separator is as high as 7.7 kPa/(g/m²) and the bond between the fibers constituting the separator is excessively strong. Since the burst index is high, it is found that the bonding area between the fibers constituting the separator is large, and it can be considered that the impregnation with the polymerization liquid or dispersion liquid of the conductive polymer is uneven. It can also be considered that, because of having a content of the fibrillated aramid of 15 mass %, the separator of Comparative Example 4 has a low denseness, so that the short-circuit failure rates of the capacitors having a high rated voltage are increased.

Also from the evaluation of the capacitors using the separator of Comparative Example 4 in addition to the evaluation of the capacitors using the separator of Comparative Example 1, it has been revealed that, when the burst index of the separator is 7.5 kPa/(g/m²) or less, the ESRs of the conductive polymer capacitors can be reduced. It is also found that, when the content of the fibrillated synthetic fibers is 20 mass % or more, the denseness of the separator can be increased and occurrence of a short-circuit failure can be suppressed.

The thickness, density, and bursting strength of the separator of Comparative Example 5 are comparable to those in Examples, but the burst index is as low as 2.9 kPa/(g/m²). The short-circuit failure rates and ESRs of the capacitors using the separator of Comparative Example 5 are higher than those in Examples.

It can be considered that the shot-circuit failure rates of the capacitors using the separator of Comparative Example 5 are increased because the burst index of the separator is as low as 2.9 kPa/(g/m²) and the bond between the fibers constituting the separator is weak. It can also be considered that, because of having a content of the fibrillated aramid of 15 mass % and a content of the acrylic of 80 mass %, the separator of Comparative Example 5 has an excessively low denseness, so that the short-circuit failure rates are increased. Furthermore, it can be considered that, because the denseness of the separator is low, the retention amounts of the conductive polymer are decreased and the ESRs are increased.

Also from the evaluation of the capacitors using the separator of Comparative Example 5 in addition to the evaluation of the capacitors using the separator of Comparative Example 2, it has been revealed that, when the burst index of the separator is 3.5 kPa/(g/m²) or more, occurrence of a short-circuit failure can be suppressed in the conductive polymer capacitors. It is also found that, when the content of the fibrillated synthetic fibers is 20 mass % or more and the content of the non-fibrillated synthetic fibers is 75 mass % or less, the denseness of the separator can be increased, so that occurrence of a short-circuit failure can be suppressed while the ESRs of the capacitors are not deteriorated.

The thickness, density, and burst index of the separator of Comparative Example 6 are comparable to those in Examples, but the burst strength is as low as 35 kPa. The short-circuit failure rates of the capacitors using the separator of Comparative Example 6 are higher than those in Examples.

It is considered that the short-circuit failure rates of the capacitors using the separator of Comparative Example 6 are increased because the bursting strength of the separator is as low as 35 kPa, the separator cannot withstand the various forces in various directions applied to the separator at the time of winding the element and inside the wound element, a partial defect occurs in the separator, and the separation between the anode foil and the cathode foil becomes insufficient. It is also considered that, because of having a content of the ethylene vinyl alcohol copolymer of 3 mass %, the separator of Comparative Example 6 has a decreased bursting strength.

From this, it has been revealed that, when the bursting strength of the separator is 40 kPa or more, occurrence of a short-circuit failure can be suppressed in the conductive polymer capacitors. It is also found that, when the content of the binder is 5 mass % or more, the bursting strength of the separator can be increased, and the resistance to short-circuiting of the separator can be increased.

The separator of Conventional Example 1 is the same as the separator described in Example 1 of Patent Literature 1. The burst index of the separator of Conventional Example 1 is as low as 2.8 kPa/(g/m²). Therefore, the short-circuit failure rates are high also in the evaluation results of the capacitors.

The separator of Conventional Example 2 is the same as the separator described in Example 1 of Patent Literature 2. The burst index of the separator of Conventional Example 2 is as low as 3.3 kPa/(g/m²). Therefore, the short-circuit failure rates are high also in the evaluation results of the capacitors.

From the comparison of the evaluation results of the capacitors using the separators of Conventional Example 1 and Conventional Example 2 with those in Examples, it is found that only containing 20-70 mass % of the fibrillated synthetic fibers and 10-75 mass % of the non-fibrillated synthetic fibers in the separators is not enough to suppress occurrence of a short-circuit failure and it is necessary to contain a binder. It has also been revealed that, when the burst index of the separator is 3.5 kPa/(g/m²) or more, occurrence of a short-circuit failure can be suppressed.

Furthermore, it is considered that the separator of Conventional Example 2 is a separator whose wet tensile strength is controlled and that has resistance to a force from one direction, but the separator has weak resistance to various forces in various directions, so that occurrence of a short-circuit failure cannot be suppressed. From this, it is found that, by controlling the bursting strength and the burst index to be within certain ranges, the stability against various forces in various directions can be increased, so that occurrence of a short-circuit failure can be suppressed.

The separator of Conventional Example 3 is the same as the separator described in Example 1 of Patent Literature 3. The burst index of the separator of Conventional Example 3 is as high as 7.8 kPa/(g/m²). In the evaluation results of the capacitors using the separator of Conventional Example 3, the short-circuit failure rates are high, and the ESRs are also high.

It can be considered that, because of including non-fibrillated synthetic fibers and polyvinyl alcohol, the separator of Conventional Example 3 has a low denseness, so that the short-circuit failure rates of the capacitors are increased. It can also be considered that the ESRs of the capacitors using the separator of Conventional Example 3 are increased because the burst index is as high as 7.8 kPa/(g/m²).

From the comparison of the evaluation results of the capacitors in Conventional Example 2 and Conventional Example 3 with those in Examples, only controlling the average pore size of the separator is not enough to suppress occurrence of a short-circuit failure in the conductive polymer capacitors, and it is necessary to increase the stability against the various forces in various directions applied to the separator at the time of winding the element and inside the wound element. That is, it has been revealed that it is necessary to control the bursting strength and burst index of the separator to be within certain ranges.

The separator of Conventional Example 4 is the same as the separator described in Example 1 of Patent Literature 4. In the evaluation results of the capacitors using the separator of Conventional Example 4, the short-circuit failure rates are high, and the ESRs are also high.

It can be considered that the short-circuit failure rates of the capacitors using the separator of Conventional Example 4 are increased because the bursting strength of the separator of Conventional Example 4 is as low as 37 kPa and the burst index is as low as 2.0 kPa/(g/m²), and the capacitor cannot withstand the various forces in various directions applied to the separator at the time of winding the element and inside the wound element. It is also considered that, because the separator of Conventional Example 4 has a content of cellulose of 15 mass %, the bursting strength of the separator is decreased when the polymerization liquid or dispersion liquid of the conductive polymer is impregnated and retained, so that the short-circuit failure rates are further increased. Furthermore, it is considered that, because cellulose is contained, the impregnation property and retention property of the polymerization liquid or dispersion liquid of the conductive polymer are decreased, so that the ESRs are increased.

From the comparison of the evaluation results of the capacitors in Conventional Example 4 with those in Examples, it is found that, in the separator containing cellulose, the resistance to short-circuiting cannot be increased while the impregnation property and retention property of the polymerization liquid or dispersion liquid of the conductive polymer are maintained, and it is necessary to constitute the separator with only synthetic fibers and a binder.

According to the embodiment of the present invention, by controlling the bursting strength of the separator including synthetic fibers and a binder to be 40-180 kPa and the burst index to be 3.5-7.5 kPa/(g/m²), it is possible to increase the stability against the various forces in various directions applied to the separator at the time of winding the element and inside the wound element after being wound while maintaining the impregnation property and retention property of the polymerization liquid or dispersion liquid of the conductive polymer, as described above. Therefore, occurrence of a partial defect in the separator can be suppressed. And, it is possible to suppress occurrence of a short-circuit failure in a conductive polymer capacitor using the separator of the present invention without deteriorating the ESR.

In addition, by controlling the modulus of elasticity of the separator to be in the range of 500-2000 MPa, the adhesion between the electrode foil and the separator can be controlled, and the ESR of the conductive polymer capacitor can be reduced.

As described above, the conductive polymer capacitor using the separator of the present embodiment can suppress occurrence of a short-circuit failure without deteriorating the ESR. Furthermore, it can also contribute to an increase in the withstand voltage of the conductive polymer capacitor.

1. A separator for an aluminum electrolytic capacitor that is interposed between a pair of electrodes and is used in an aluminum electrolytic capacitor having a conductive polymer as a cathode material,
the separator comprising synthetic fibers and a binder, and having a bursting strength of 40-180 kPa and a burst index of 3.5-7.5 kPa/(g/m²).

2. The separator for an aluminum electrolytic capacitor according to claim 1, wherein the synthetic fibers include fibrillated synthetic fibers and non-fibrillated synthetic fibers.

3. The separator for an aluminum electrolytic capacitor according to claim 2, wherein the separator contains 70-95 mass % of the synthetic fibers and 5-30 mass % of the binder, and contains 20-70 mass % of the fibrillated synthetic fibers and 10-75 mass % of the non-fibrillated synthetic fibers based on a total mass of the separator.

4. The separator for an aluminum electrolytic capacitor according to claim 1, wherein a modulus of elasticity is 500-2000 MPa.

5. An aluminum electrolytic capacitor using a conductive polymer as a cathode material,
the aluminum electrolytic capacitor using the separator according to claim 1.

6. The separator for an aluminum electrolytic capacitor according to claim 2, wherein a modulus of elasticity is 500-2000 MPa.

7. The separator for an aluminum electrolytic capacitor according to claim 3, wherein a modulus of elasticity is 500-2000 MPa.

8. An aluminum electrolytic capacitor using a conductive polymer as a cathode material,
the aluminum electrolytic capacitor using the separator according to claim 2.

9. An aluminum electrolytic capacitor using a conductive polymer as a cathode material,
the aluminum electrolytic capacitor using the separator according to claim 3.

10. An aluminum electrolytic capacitor using a conductive polymer as a cathode material,
the aluminum electrolytic capacitor using the separator according to claim 4.

11. An aluminum electrolytic capacitor using a conductive polymer as a cathode material,
the aluminum electrolytic capacitor using the separator according to claim 6.

12. An aluminum electrolytic capacitor using a conductive polymer as a cathode material,
the aluminum electrolytic capacitor using the separator according to claim 7.
